(19) United States
(12) Patent Application Publication
(10) Pub. No.: US 2022/0036923 A1
(43) Pub. Date: Feb. 3, 2022

(54) MAGNETIC DISK DEVICE

(71) Applicants: Kabushiki Kaisha Toshiba, Tokyo (JP); Toshiba Electronic Devices & Storage Corporation, Tokyo (JP)

(72) Inventor: Gaku Koizumi, Kawasaki Kanagawa (JP)

(21) Appl. No.: 17/375,183

(22) Filed: Jul. 14, 2021

(30) Foreign Application Priority Data
Jul. 30, 2020 (JP) 2020-129105

(51) Int. Cl. G11B 20/22; G11B 5/127; G11B 21/02

(52) U.S. Cl. CPC G11B 20/22; G11B 21/02; G11B 5/1278

(57) ABSTRACT

According to one embodiment, a magnetic disk device comprises an actuator configured to drive a head stack assembly including a plurality of magnetic heads, a preamplifier connected to each of the magnetic heads with a plurality of traces, and a control section configured to control read/write of the plurality of magnetic heads from/to the magnetic disk through the preamplifier. While a first magnetic head among the plurality of magnetic heads executes a write operation, the control section interrupts access of a second magnetic head in proximity to the first magnetic head to the magnetic disk.

### CROSS-REFERENCE TO RELATED APPLICATIONS

This application is based upon and claims the benefit of priority from Japanese Patent Application No. 2020-129105, filed Jul. 30, 2020, the entire contents of which are incorporated herein by reference.

### FIELD

Embodiments described herein relate generally to a magnetic disk device

### BACKGROUND

A magnetic disk device provided with an overshoot control circuit configured to control an overshoot amount after a reversal of polarity of a recording current according to the magnitude of the drive current is known.

Further, in a magnetic disk device, there is sometimes a case where crosstalk noise generated from a magnetic head making write access to the magnetic disk interferes with a read element, assist recording element, and the like of another magnetic head in proximity to the magnetic head concerned. In this case, there is apprehension that read characteristics and positioning accuracy of the other magnetic head are adversely affected and, furthermore, a failure such as breakage of the elements occurs.

Embodiments described herein aim to provide a magnetic disk device capable of avoiding occurrence of a failure attributable to crosstalk noise.

### BRIEF DESCRIPTION OF THE DRAWINGS

FIG. 1 is a view showing an example of the control configuration of a magnetic disk device according to a first embodiment.

FIG. 2 is a perspective view showing an example of a track center cross section of a recording head section of a magnetic head according to the first embodiment.

FIG. 3 is a cross-sectional view showing an example of each of the recording head section of the magnetic head and magnetic disk according to the first embodiment.

FIG. 4 is a view showing an example of traces according to the first embodiment.

FIG. 5 is a flowchart showing an example of processing to be executed by a control circuit according to the first embodiment.

FIG. 6 is a view showing an example of an operation according to the first embodiment.

FIG. 7 is a view showing an example of the control configuration of a magnetic disk device according to a second embodiment.

FIG. 8 is a view showing an example of traces according to the second embodiment.

FIG. 9 is a flowchart showing an example of processing to be executed by a control circuit according to the second embodiment.

FIG. 10 is a view showing an example of an operation according to the second embodiment.

FIG. 11 is a flowchart showing an example of processing to be executed by a control circuit according to a third embodiment.

FIG. 12 is a view showing an example of an operation according to the third embodiment.

FIG. 13 is a view showing an example of traces according to a fourth embodiment.

FIG. 14 is a flowchart showing an example of processing to be executed by a control circuit according to the fourth embodiment.

FIG. 15 is a view showing an example of an operation according to the fourth embodiment.

FIG. 16 is a view showing an example of traces according to a fifth embodiment.

FIG. 17 is a flowchart showing an example of processing to be executed by a control circuit according to the fifth embodiment.

FIG. 18 is a view showing an example of an operation according to the fifth embodiment.

FIG. 19 is a view showing an example of traces according to the sixth embodiment.

FIG. 20 is a flowchart showing an example of processing to be executed by a control circuit according to the sixth embodiment.

FIG. 21 is a view showing an example of an operation according to the sixth embodiment.

### DETAILED DESCRIPTION

In general, according to one embodiment, a magnetic disk device comprises an actuator configured to drive a head stack assembly including a plurality of magnetic heads, a preamplifier connected to each of the magnetic heads with a plurality of traces, and a control section configured to control read/write of the plurality of magnetic heads from/to the magnetic disk through the preamplifier. While a first magnetic head among the plurality of magnetic heads executes a write operation, the control section interrupts access of a second magnetic head in proximity to the first magnetic head to the magnetic disk.

In general, according to one embodiment, a magnetic disk device comprises an actuator configured to drive a head stack assembly including a plurality of magnetic heads, a preamplifier connected to each of the magnetic heads with a plurality of traces, and a control section configured to control read/write of the plurality of magnetic heads from/to the magnetic disk through the preamplifiers. While a first magnetic head among the plurality of magnetic heads executes a write operation, the control section reduces an operating voltage of a second magnetic head positioned in proximity to the first magnetic head, the operating voltage being relative to the magnetic disk.

Embodiments will be described hereinafter with reference to the accompanying drawings. Note that the disclosure is merely an example, and the invention is not limited by the contents of the embodiments provided below. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same elements as those described in connection with preceding drawings are denoted by like reference numerals, and a detailed description thereof is omitted unless otherwise necessary.

### First Embodiment

In a first embodiment, in a case where a plurality of heads are configured to be able to simultaneously make access within one actuator, in order to suppress crosstalk noise between the heads (or traces) when the heads in proximity to each other make simultaneous access, at the time of simultaneous access of the heads in proximity to each other and, further, at the time of simultaneous write access, when one head carries out write, write of the other head is restricted. Hereinafter, descriptions will be given in detail.

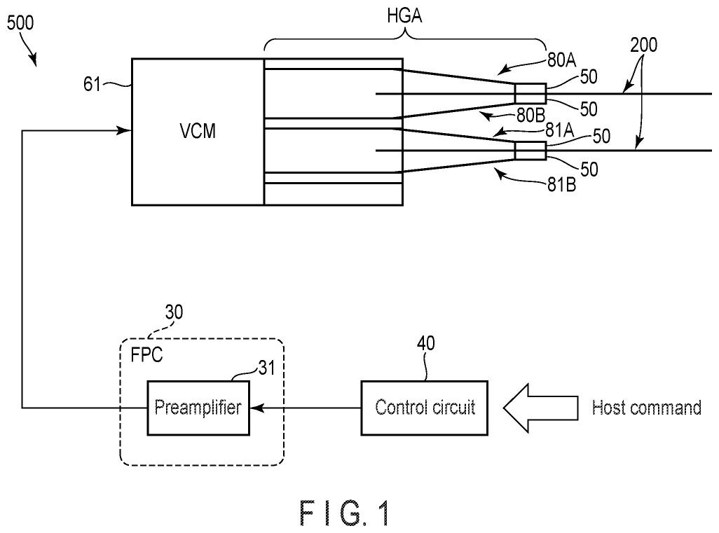

FIG. 1 is a view showing an example of the control configuration of a magnetic disk device 500.

The magnetic disk device 500 includes a flexible printed circuit board (FPC) 30, control circuit (control section) 40, voice coil motor (VCM) 61, head gimbal assemblies (HGAs) 80A, 80B, 81A, and 81B, and magnetic disks 200. It should be noted that the VCM 61 and HGAs 80A, 80B, 81A, and 81B constitute an actuator. The control circuit 40 is, for example, a system-on-chip, includes a disk controller, R/W channel, MPU, and the like, and controls the magnetic disk device 500. It should be noted that the magnetic disk device 500 includes a memory (not shown) connected to the control circuit 40. Upon receipt of a command from the host, the control circuit 40 outputs an instruction based on the received host command to the FCP 30. For example, upon receipt of a write command from the host, the control circuit 40 outputs an instruction to write data to a specified position to the FPC 30.

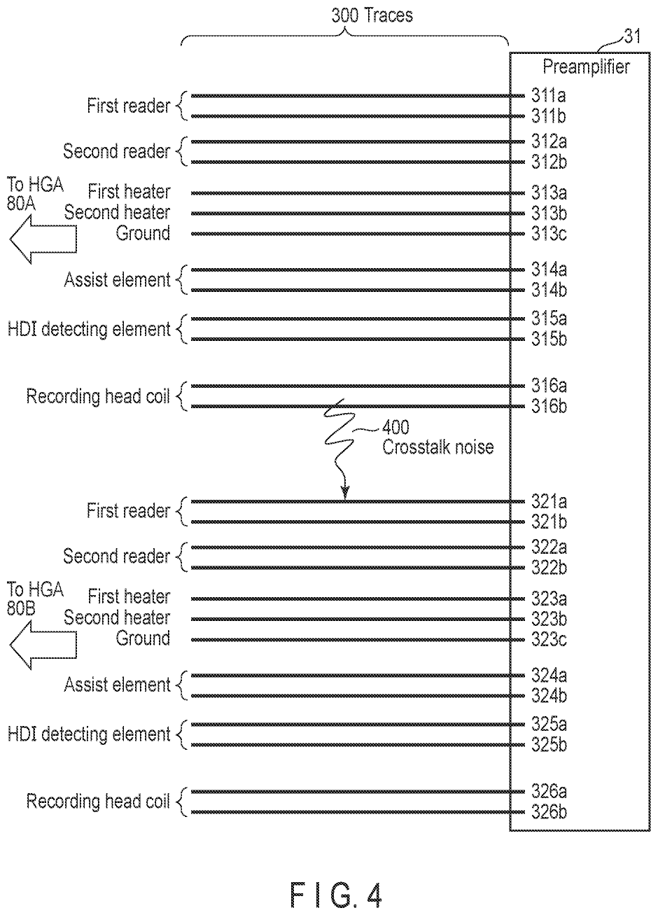

The FPC 30 includes a preamplifier 31. The preamplifier 31 outputs the instruction received from the control circuit 40 to the HGAs 80A, 80B, 81A, and 81B through traces 300. A detailed description of the traces 300 will be given later with reference to FIG. 4.

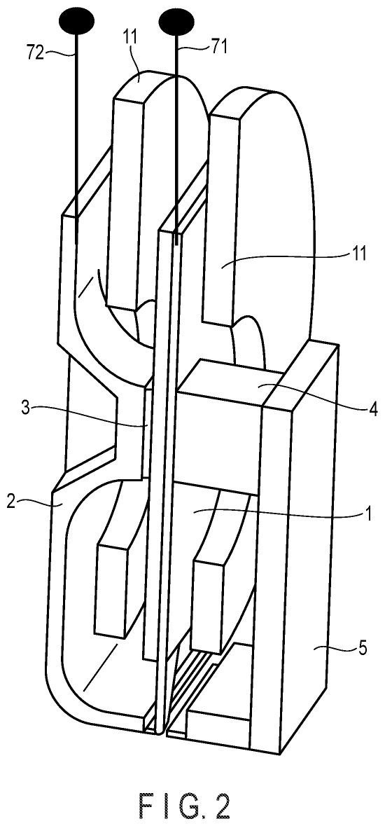

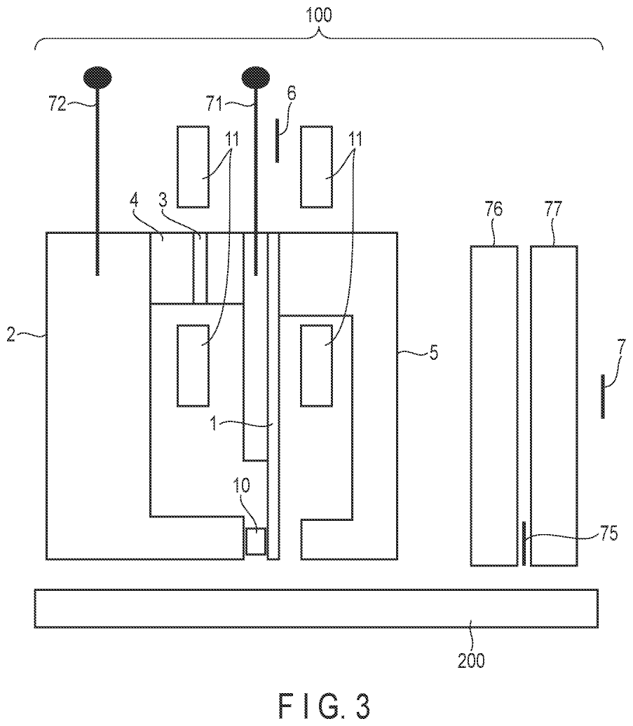

The preamplifier 31 is connected to the VCM 61. The VCM 61 includes the already-described HGAs 80A, 80B, 81A, and 81B. The HGAs 80A, 80B, 81A, and 81B are arranged in this order mentioned from the upper side in FIG. 1 in stacked layers. The HGA 80A accesses the front surface of the magnetic disk 200, and HGA 80B accesses the rear surface of the magnetic disk 200. Likewise, the HGA 81A accesses the front surface of another magnetic disk 200, and HGA 81B accesses the rear surface of the other magnetic disk 200. At a tip of each of the HGAs 80A, 80B, 81A, and 81B, a slider 50 is provided. The slider 50 includes a magnetic head (hereinafter, simply referred to also as a “head”). A detailed description of the magnetic head will be given later by using FIG. 2 and FIG. 3.

In the magnetic disk device 500 configured as described above, when a write command to record data on the magnetic disk 200 is transmitted from the host to the control circuit 40, access-object head information, data to be recorded, control clock, and the like are transferred from the control circuit 40 to the preamplifier 31. The preamplifier 31 makes, according to the control clock, a recording current flow through each of the magnetic heads (recording head coils) 100 inside the slider 50 connected to the VCM 61 and including the access-object head. In this embodiment, the HGAs 80A, 80B, 81A, and 81B respectively connected to the VCM 61 can be controlled independently of each other. Accordingly, although in the magnetic disk device 500, the performance of access to the magnetic disk 200 can be improved, a case where HGAs adjacent to each other in the stacking direction of the HGAs simultaneously carry out write of data sometimes occurs.

FIG. 2 is a perspective view showing an example of a track center cross section of a recording head section of the magnetic head 100. Further, FIG. 3 is a cross-sectional view showing an example of each of the recording head section of the magnetic head 100 and magnetic disk.

The magnetic disk 200 of this embodiment is a vertical recording medium including recording layers having anisotropy in the direction perpendicular to the disk surface. The magnetic head 100 is a separation type magnetic head in which the recording head and reproducing head are separated from each other. The recording head section is constituted of a main pole 1 formed of a high magnetic permeability material, return pole 2 provided for the purpose of efficiently close the magnetic path through a soft magnetic layer of the vertical head directly under the main pole and arranged on the trailing side of the main pole 1, recording head coils 11 arranged in such a manner as to be wound around the magnetic path including the main pole and return pole 2 in order to make the magnetic flux flow through the main pole 1, and assist element 10 arranged in such a manner as to be interposed between the return pole 2 and main pole 1. When the assist section configured to assist write of data is a high-frequency assist section, the assist element 10 is a spin-torque-oscillator (STO) element and, when the assist section is a thermal assist section, the assist element 10 is an element to be used for emission of laser light.

A first terminal 71 is connected to the main pole 1, and second terminal 72 is connected to the return pole 2. The two recording head coils 11 are wound in directions opposite to each other and, by making an AC current flow through the recording head coils 11, the main pole 1 is energized. Further, in order to control the amount of levitation of the magnetic head 100 from the recording surface of the magnetic disk 200 at the time of recording/reproduction of the magnetic head 100, a first heater 6 arranged on the depth side of the recording element section, first reader 75, and second heater 7 arranged on the depth side of reproducing element sections of the first reader 75, the reproducing element sections having shield films 76 and 77 are provided. It should be noted that although in FIG. 3, only the first reader 75 is shown, a second reader is provided at a predetermined position in the page surface direction. Furthermore, although illustration is omitted, the magnetic head 100 is provided with a head disk interface (HDI) detecting element to be used to detect an amount of levitation of the magnetic head 100 from the disk surface at a predetermined position thereof.

Here, a case where the access-object heads which become the objects of write operations are the HGA 80A and HGA 80B arranged adjacent to each other as shown in FIG. 1 is assumed. FIG. 4 is a view showing an example of traces 300 indicating trace wiring members connecting the preamplifier 31 and each of the HGA 80A and HGA 80B to each other.

First, the connection between the preamplifier 31 and the HGA 80A will be described below.

The preamplifier 31 is connected to the first reader 75 with the traces 311a and 311b, and is connected to the second reader (illustration is omitted in FIG. 3) with the traces 312a and 312b. Further, the preamplifier 31 is connected to the first heater 6 with the trace 313a, is connected to the second heater 7 with the trace 313b, and is connected to the ground with the trace 313c. Furthermore, the preamplifier 31 is connected to the assist element 10 with the traces 314a and 314b, is connected to the HDI detecting element (illustration is omitted in FIG. 3) with the traces 315a and 315b, and is connected to the recording head coil 11 with the traces 316a and 316b.

Next, the connection between the preamplifier 31 and the HGA 80B will be described below.

As in the case of the HGA 80A, the preamplifier 31 is connected to the first reader 75 with the traces 321a and 321b, and is connected to the second reader (illustration is omitted in FIG. 3) with the traces 322a and 322b. Further, the preamplifier 31 is connected to the first heater 6 with the trace 323a, is connected to the second heater 7 with the trace 323b, and is connected to the ground with the trace 323c. Furthermore, the preamplifier 31 is connected to the assist element 10 with the traces 324a and 324b, is connected to the HDI detecting element (illustration is omitted in FIG. 3) with the traces 325a and 325b, and is connected to the recording head coil 11 with the traces 326a and 326b.

The arrangement of the traces connecting the preamplifier 31 to the HGA 80A and HGA 80B is as follows; as to the HGA 80A, the traces 311a and 311b to be connected to the first reader 75, traces 312a and 312b to be connected to the second reader, trace 313a to be connected to the first heater 6, trace 313b to be connected to the second heater 7, trace 313c to be connected to the ground, traces 314a and 314b to be connected to the assist element 10, traces 315a and 315b to be connected to the HDI detecting element, and traces 316a and 316b to be connected to the recording head coil 11 are respectively arranged in the order mentioned and, in order to be adjacent to the above arrangement, as to the HGA 80B, the traces 321a and 321b to be connected to the first reader 75, traces 322a and 322b to be connected to the second reader, trace 323a to be connected to the first heater 6, trace 323b to be connected to the second heater 7, trace 323c to be connected to the ground, traces 324a and 324b to be connected to the assist element 10, traces 325a and 325b to be connected to the HDI detecting element, and traces 326a and 326b to be connected to the recording head coil 11 are arranged in the order mentioned. Accordingly, the traces 316a and 316b to be connected to the recording head coil 11 and traces 321a and 321b to be connected to the first reader are arranged adjacent to each other.

When a data recording operation of the HGA 80A is carried out, crosstalk noise 400 is generated from the traces 316a and 316b. The voltage to be applied to the recording head coil 11 is greater than the voltages to be applied to the other traces, and hence this crosstalk noise exerts an influence upon the other traces. Therefore, when the traces 300 are configured as shown in FIG. 4, if the timing of the data recording operation of the HGA 80A and timing of the data reproducing operation of the HGA 80B overlap each other, the reproducing operation of the HGA 80B is influenced by the crosstalk noise 400. That is, the crosstalk noise 400 is superposed on a signal to be transmitted from the first reader 75 to the preamplifier 31 through the traces 321a and 321b, and there is a possibility of a significant failure being caused to the reproducing operation of the HGA 80B.

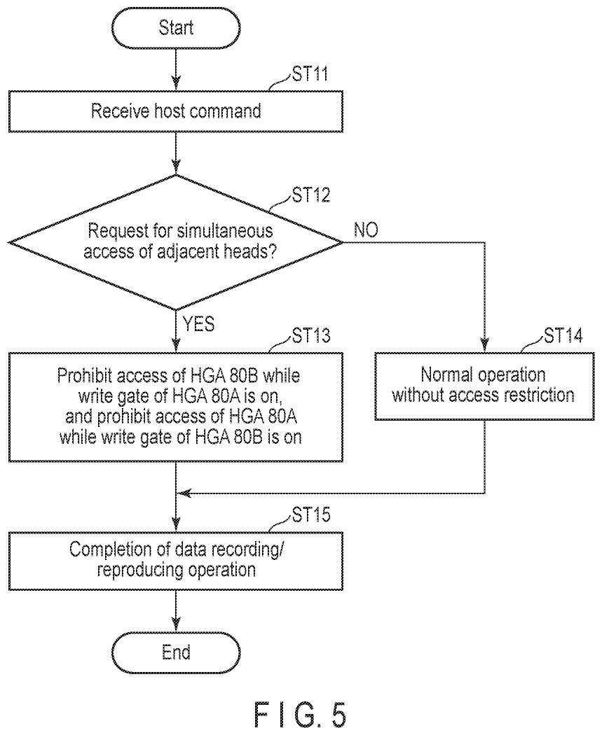

A method for avoiding the failure attributable to such crosstalk noise 400 will be described below. FIG. 5 is a flowchart showing an example of processing by which the control circuit 40 executes the method concerned.

As shown in FIG. 5, when the magnetic disk device 500 receives a host command from the host (ST11), the control circuit 40 determines whether or not the host command is a request for simultaneous access of adjacent heads (ST12). More specifically, the control circuit 40 determines whether or not the host command is a command requiring simultaneous access of the HGAs adjacent to each other.

Next, upon determination that the host command is a request for simultaneous access of the adjacent heads (ST12: YES), e.g., upon receipt of a command requiring simultaneous access of the HGA 80A and HGA 80B, the control circuit 40 prohibits the access of the HGA 80B while the write gate of the HGA 80A is on, and prohibits the access of the HGA 80A while the write gate of the HGA 80B is on (ST13). Here, the expression ‘write gate is on’ implies that in each of the adjacent heads, the recording head coil 11 is energized through the traces 316a and 316b or through the traces 326a and 326b.

On the other hand, upon determination that the host command is not a request for simultaneous access of the adjacent heads (ST12: NO), the control circuit 40 carries out a normal operation without access restriction (ST14). As described above, on the basis of the determination whether or not the host command is a command requiring simultaneous access of the adjacent heads, the control circuit 40 carries out control with respect to the HGA 80A and HGA 80B adjacent to each other in such a manner as to carry out, while one of the HGAs 80A and 80B is in the recording operation, an interruption of the recording operation of the other of them and, upon completion of the data recording/reproducing operation (ST15), the control circuit 40 terminates this processing.

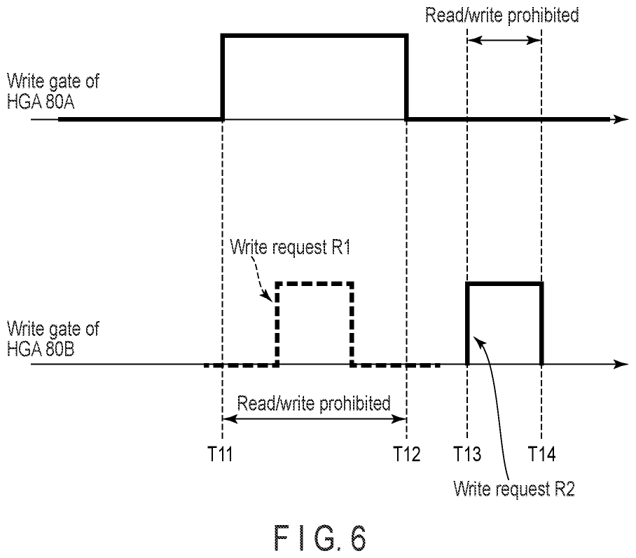

FIG. 6 is a view showing an example of an operation of the processing of the step ST13 already described previously.

In FIG. 6, the upper part of the drawing shows the recording operation of the HGA 80A, and lower part thereof shows the recording operation of the HGA 80B. The state where the waveform is at the rise-level indicates the on-state of the write gate, i.e., the state where a current is flowing through the recording head coil 11.

As shown in FIG. 6, while the write gate of the HGA 80A is on, i.e., during the period from the time T11 to the time T12, read/write of the HGA 80B is interrupted. When a write request R1 happens to the HGA 80B within the above period, the control circuit 40 outputs, after the period from the time T11 to the time T12 is over, the write request R1 as a write request R2. In FIG. 6, the control circuit 40 makes the write gate of the HGA 80B on during the period from the time T13 to the time T14 to thereby carry out data recording based on the write request R2. During the period from the time T13 to the time T14, the control circuit 40 interrupts read/write of the HGA 80A.

As described above, when there is a request for simultaneous access of the adjacent magnetic heads 100, the control circuit 40 changes the timing of each recording operation in such a manner that the recording operations do not overlap each other in the magnetic heads 100 adjacent to each other. Thereby, the signal read from the first reader 75 becomes unsusceptible to superposition of the crosstalk noise. Accordingly, it becomes possible for the magnetic disk device 500 to avoid occurrence of a failure attributable to the crosstalk noise.

### Second Embodiment

This embodiment is an embodiment relating to a magnetic disk device including a multi-actuator, and differs from the first embodiment in that a recording/reproducing operation is carried out in units of actuators. In this embodiment, the processing to be carried out at the time when, among the actuators of the multi-actuator, two actuators arranged closest to each other simultaneously make access to the magnetic disk will be described below. It should be noted that configurations identical to the first embodiment are denoted by reference symbols identical to the first embodiment and detailed descriptions of these configurations are omitted. It should be noted that also as to the third to sixth embodiments to be described later, as in the case of the second embodiment, the processing to be carried out at the time when, among the actuators of the multi-actuator, two actuators arranged closest to each other simultaneously make access to the magnetic disk will be described.

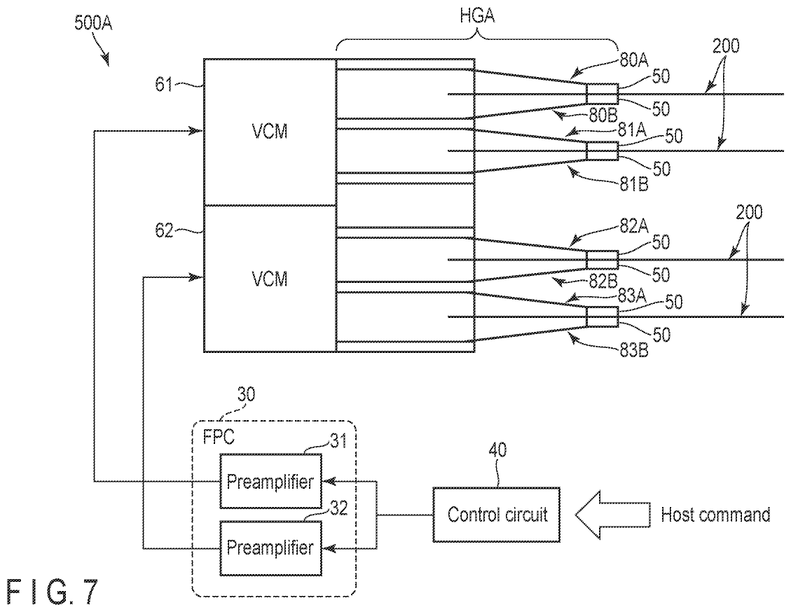

FIG. 7 is a view showing an example of the control configuration of a magnetic disk device 500A.

The magnetic disk device 500A differs from the magnetic disk device 500 already described previously in that a preamplifier 32 is added to the FPC 30 and a VCM 62 is further added thereto. The VCM 62 is provided with HGAs 82A, 82B, 83A, and 83B. Each of the HGAs 82A, 82B, 83A, and 83B is provided with a slider 50 at a tip section thereof. The magnetic disk device 500A is configured in such a manner that the HGA 82A accesses the front surface of the magnetic disk 200, HGA 82B accesses the rear surface of the magnetic disk 200 and, HGA 83A accesses the front surface of another magnetic disk 200, and HGA 83B accesses the rear surface of the other magnetic disk 200. Each of this embodiment and the subsequent embodiments is configured in such a manner that the recording/reproducing operation is not carried out in units of HGAs unlike in the previously described case, and the recording/reproducing operation is carried out in units of actuators (VCMs).

In the magnetic disk device 500A configured as described above, when a write command to record data on the magnetic disk 200 is transmitted from the host to the control circuit 40, access-object head information, data to be recorded, control clock, and the like are transferred from the control circuit 40 to each of the preamplifier 31 and preamplifier 32. The preamplifier 31 makes, according to the control clock, a recording current flow through each of the recording head coils 11 in the sliders 50 including the access-object head and connected to the VCM 61. Further, the preamplifier 32 makes, according to the control clock, a recording current flow through each of the recording head coils 11 in the sliders 50 including the access-object head and connected to the VCM 62. In this embodiment, the VCM 61 and VCM 62 are controlled independently of each other. Accordingly, a case where the HGA 81B and HGA 82A adjacent to each other in the stacking direction of the VCM 61 and VCM 62 simultaneously carry out write of data sometimes occurs.

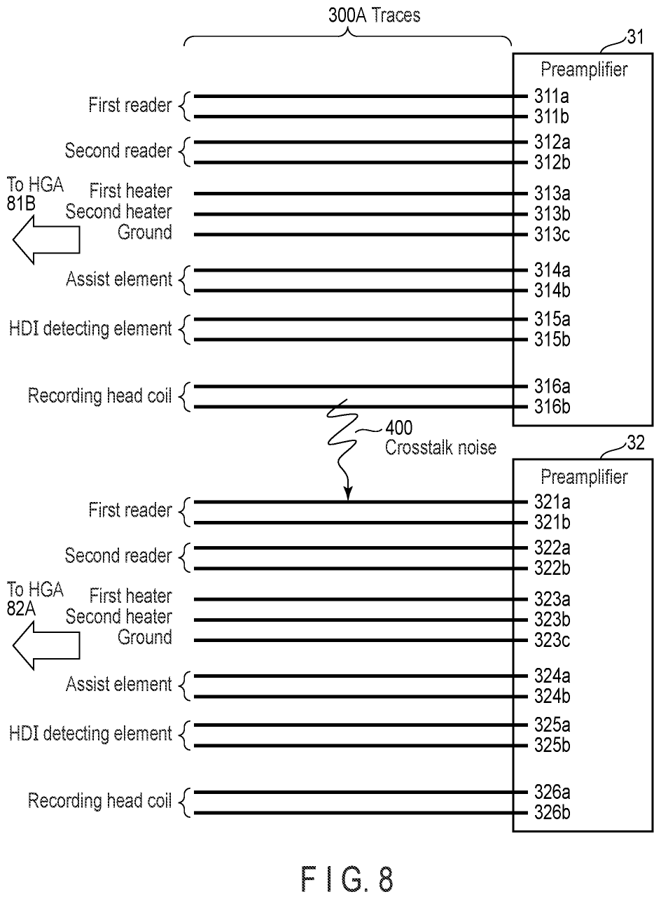

FIG. 8 is a view showing an example of traces 300A indicating trace wiring members respectively connecting the preamplifier 31 to the HGA 81B, and connecting the preamplifier 32 to the HGA 82A.

The trace wiring between the preamplifier 31 and HGA 81B is identical to the trace wiring between the preamplifier 31 and HGA 80A already described previously, and wiring between the preamplifier 32 and HGA 82A is identical to the wiring between the preamplifier and HGA 80B already described previously (see FIG. 4). Here, although the HGA 81B and HGA 82A are respectively provided in the VCM 61 and VCM 62 different from each other, and are respectively connected to the preamplifiers 31 and 32 different from each other, in order to compactify the trace wiring, the HGA 81B and HGA 82A are arranged in proximity to each other as shown in FIG. 8.

Accordingly, as in the case of FIG. 4, if the timing of data recording operation of the HGA 81B and timing of data reproducing operation of the HGA 82A overlap each other, the reproducing operation of the HGA 82A is influenced by the crosstalk noise. That is, the crosstalk noise is superposed on a signal to be transmitted from the first reader 75 to the preamplifier 32 through the traces 321a and 321b, and there is a possibility of a significant failure being caused to the reproducing operation of the HGA 82A.

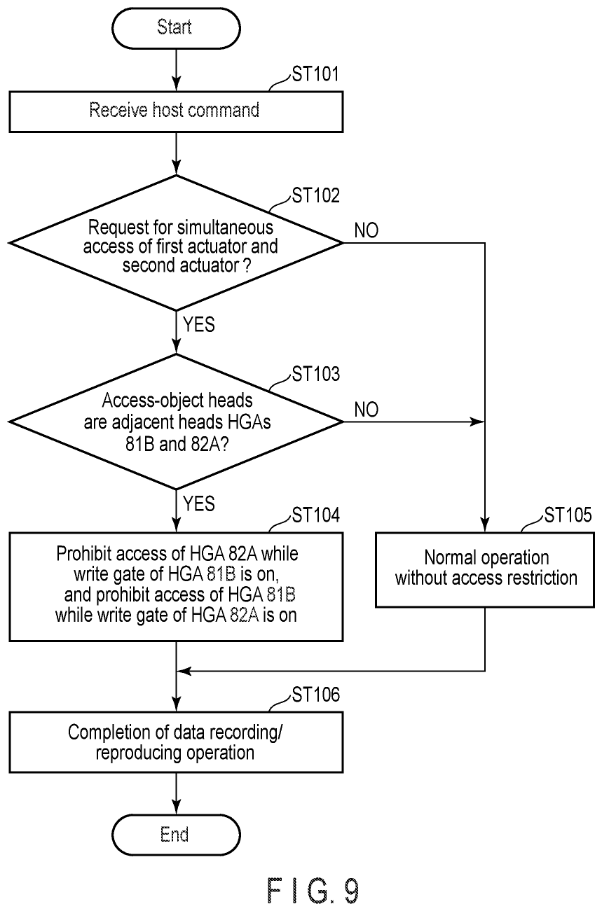

A method for avoiding the failure attributable to such crosstalk noise will be described below. FIG. 9 is a flowchart showing an example of processing by which the control circuit 40 executes the method concerned.

As shown in FIG. 9, when the magnetic disk device 500A receives a host command from the host (ST101), the control circuit 40 determines whether or not the host command is a request for simultaneous access of the first actuator and second actuator (ST102). More specifically, the control circuit 40 determines whether or not the host command is a command requiring simultaneous access of any one of the HGAs of the VCM 61 and any one of the HGAs of the VCM 62.

Next, upon determination that the host command is a request for simultaneous access of the HGAs (ST102: YES), the control circuit 40 determines whether or not the access-object heads are the adjacent heads HGA 81B and HGA 82A (ST103). Upon determination that the access-object heads are the adjacent heads HGA 81B and HGA 82A (ST103: YES), the control circuit 40 prohibits the access of the HGA 82A while the write gate of the HGA 81B is on, and prohibits the access of the HGA 81B while the write gate of the HGA 82A is on (ST104).

On the other hand, upon determination that the host command is not a request for simultaneous access of the HGAs (ST102: NO) or upon determination that the access-object heads are not the adjacent heads HGA 81B and HGA 82A (ST103: NO), the control circuit 40 carries out a normal operation without access restriction (ST105). As described above, on the basis of the determination whether or not the host command is a command requiring simultaneous access of the adjacent heads, the control circuit 40 carries out a reproducing operation and recording operation with respect to the HGA 81B and HGA 82A adjacent to each other and, upon completion of the data recording/reproducing operation (ST106), the control circuit 40 terminates this processing.

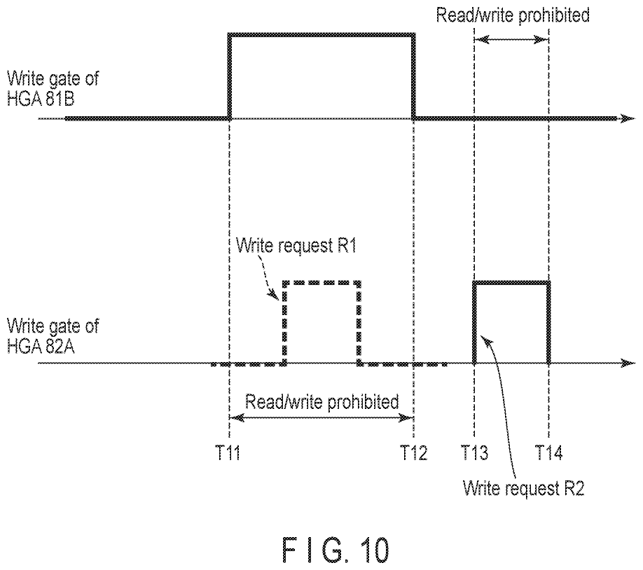

FIG. 10 is a view showing an example of an operation of the processing of the step ST104 already described previously.

As in the case of FIG. 6, while the write gate of the HGA 81B is on, i.e., during the period from the time T11 to the time T12, read/write of the HGA 82A is prohibited. When a write request R1 happens to the HGA 82A within the above period, the control circuit outputs, after the period from the time T11 to the time T12 is over, the write request R1 as a write request R2. In FIG. 10, the control circuit 40 makes the write gate of the HGA 82A on during the period from the time T13 to the time T14 to thereby carry out data recording based on the write request R2. During the period from the time T13 to the time T14, the control circuit 40 prohibits read/write of the HGA 81B.

As described above, when there is a request for simultaneous access of the HGA 81B and HGA 82A adjacent to each other, the control circuit 40 changes the timing of each recording operation in such a manner that the recording operations do not overlap each other in the HGA 81B and HGA 82A adjacent to each other. Thereby, the signal read from the first reader 75 of the HGA 82A becomes unsusceptible to superposition of the crosstalk noise. Accordingly, it becomes possible for the magnetic disk device 500A to avoid occurrence of a failure attributable to the crosstalk noise.

### Third Embodiment

In this embodiment, the method for avoiding the failure attributable to the crosstalk noise is different from the second embodiment already described previously. Accordingly, this method will be described below in detail. It should be noted that configurations identical to the second embodiment are denoted by reference symbols identical to the second embodiment and detailed descriptions of these configurations are omitted.

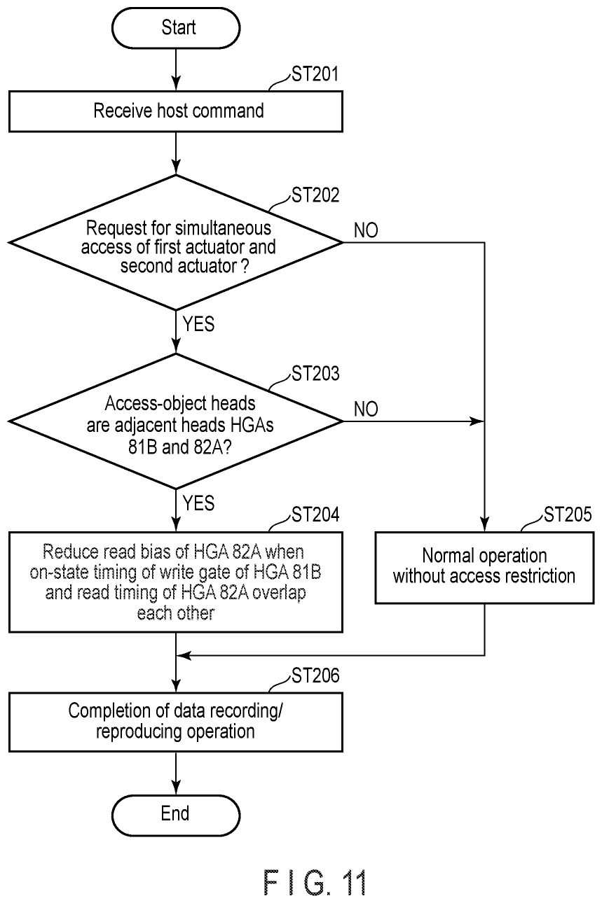

FIG. 11 is a flowchart showing an example of processing by which the control circuit 40 executes the method concerned.

As shown in FIG. 11, upon receipt of a host command (ST201), the control circuit 40 determines whether or not the host command is a request for simultaneous access of the first actuator and second actuator (ST202) and, when the host command is a request for simultaneous access of the actuators (ST202: YES), determines whether or not the access-object heads are the adjacent heads HGA 81B and HGA 82A (ST203). This processing is identical to the steps ST101 to ST103 already described previously.

Upon determination that the access-object heads are the adjacent heads HGA 81B and HGA 82A (ST203: YES), the control circuit 40 reduces, when the on-state timing of the write gate of the HGA 81B and read timing of the HGA 82A overlap each other, the read bias of the first reader 75 of the HGA 82A (ST204).

On the other hand, upon determination that the host command is not a request for simultaneous access of the adjacent heads (ST202: NO) or upon determination that the access-object heads are not the adjacent heads HGA 81B and HGA 82A (ST203: NO), the control circuit 40 carries out a normal operation without access restriction (ST205). As described above, on the basis of the determination whether or not the host command is a command requiring simultaneous access of the adjacent heads, the control circuit 40 carries out the processing of reducing the read bias of the first reader 75 of the HGA 82A and, upon completion of the data recording/reproducing operation (ST206), the control circuit 40 terminates this processing.

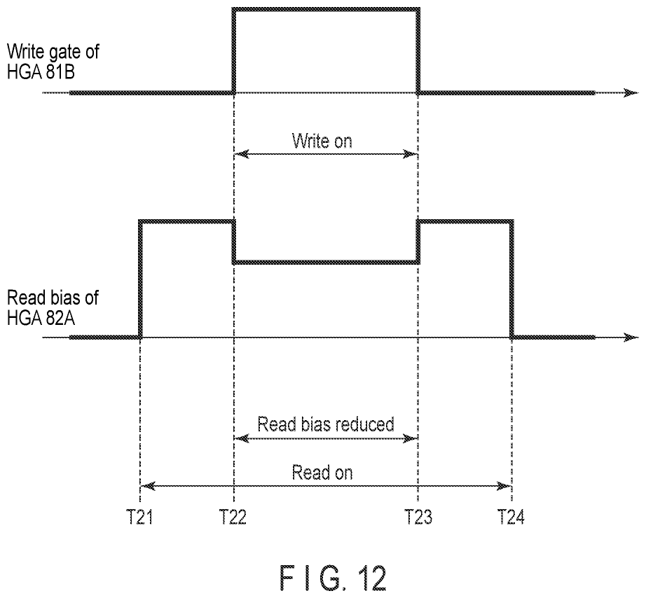

FIG. 12 is a timing chart showing an example of an operation of the processing of the step ST204 already described previously. In FIG. 12, the upper part of the drawing shows the on-state timing of the write gate of the HGA 81B, and lower part thereof shows the timing and amount of the read bias of the first reader of the HGA 82A.

As shown in FIG. 12, when there is a read request of the HGA 82A, and the read bias thereof is in the on-state (from time T21 to time T24), if the period (from time T22 to time T23) of the on-state of the write gate of the HGA 81B overlaps the above on-state period of the read bias of the HGA 82A, the read bias of the HGA 82A is reduced during the overlap period (from time T22 to time T23). Thereby, the signal read from the first reader 75 of the HGA 82A becomes unsusceptible to the influence of the crosstalk noise. Accordingly, it becomes possible for the magnetic disk device 500A to avoid occurrence of a failure attributable to the crosstalk noise.

### Fourth Embodiment

In this embodiment, the arrangement of the trace wiring differs from the second embodiment, and a case where the crosstalk noise generated from the recording head coil 11 exerts an influence on the traces of the assist element 10 will be described below. It should be noted that configurations identical to the second embodiment described above are denoted by reference symbols identical to the second embodiment and detailed descriptions of these configurations are omitted.

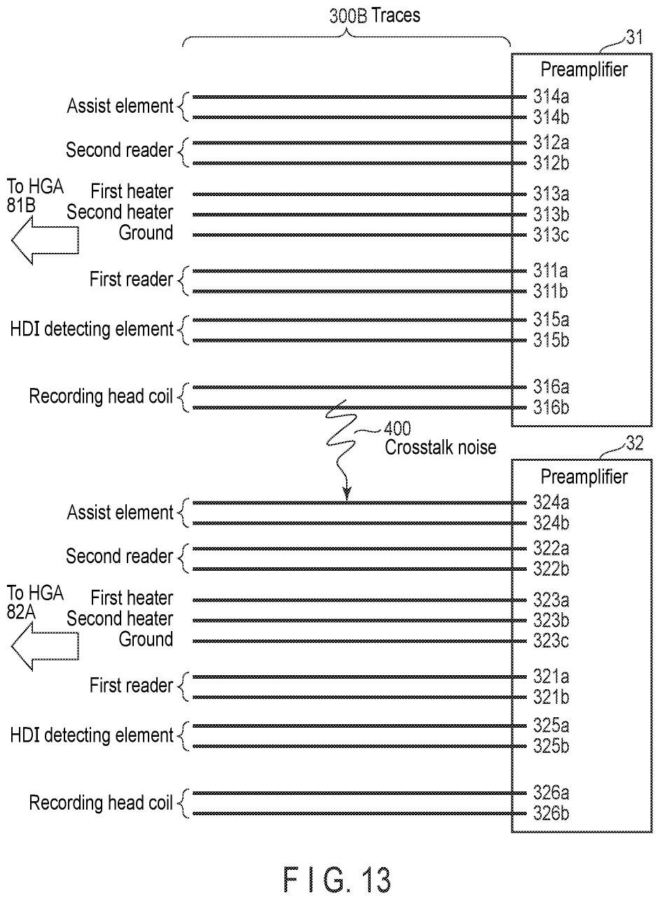

FIG. 13 is a view showing the traces 300B of the HGA 81B and HGA 82A respectively included in the VCM 61 and VCM 62 different from each other and arranged adjacent to each other.

As shown in FIG. 13, in the traces 300B from the preamplifier 31 to the HGA 81B, the traces 311a and 311b to be connected to the first reader 75 and traces 314a and 314b to be connected to the assist element 10 switch their places with each other as compared with FIG. 8 and, in the traces 300B from the preamplifier 32 to the HGA 82A, the traces 321a and 321b to be connected to the first reader 75 and traces 324a and 324b to be connected to the assist element 10 switch their places with each other as compared with FIG. 8. That is, the traces 324a and 324b to be connected to the assist element 10 of the HGA 82A are arranged in proximity to the arrangement position of the traces 316a and 316b to be connected to the recording head coil 11 of the HGA 81B. Accordingly, although the signal from the first reader 75 becomes unsusceptible to the influence of the crosstalk noise, on the other hand, the need for avoiding occurrence of a failure attributable to the crosstalk noise arises as to the assist element 10.

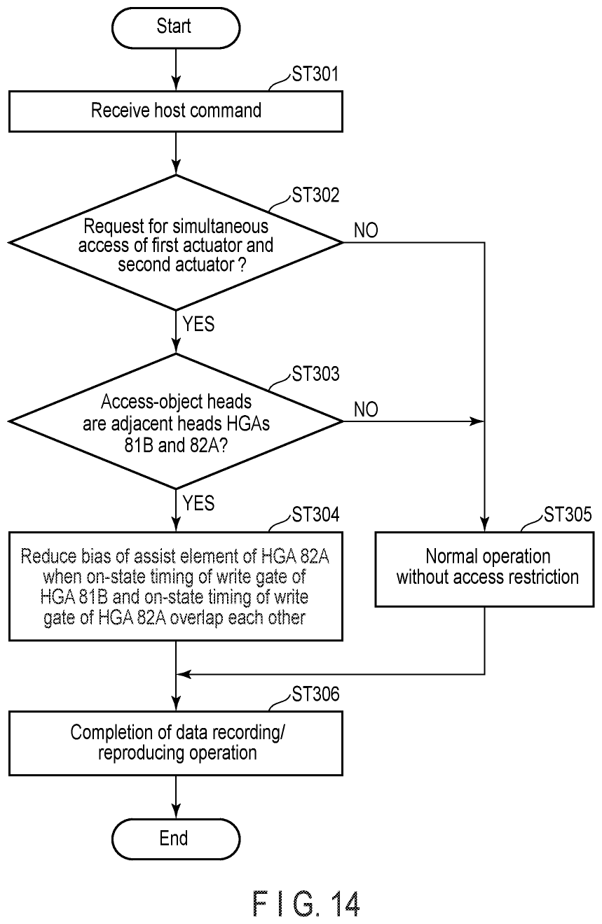

FIG. 14 is a flowchart showing an example of processing by which the control circuit 40 executes the method concerned.

As shown in FIG. 14, upon receipt of a host command (ST301), the control circuit 40 determines whether or not the host command is a request for simultaneous access of the first actuator and second actuator (ST302) and, when the command is a request for simultaneous access of the actuators (ST302: YES), determines whether or not the access-object heads are the adjacent heads HGA 81B and HGA 82A (ST303). This processing is identical to the steps ST101 to ST103 already described previously.

Upon determination that the access-object heads are the adjacent heads HGA 81B and HGA 82A (ST303: YES), the control circuit 40 reduces, when the on-state timing of the write gate of the HGA 81B and on-state timing of the write gate of the HGA 82A overlap each other, the bias of the assist element 10 of the HGA 82A (ST304).

On the other hand, upon determination that the host command is not a request for simultaneous access of the adjacent heads (ST302: NO) or upon determination that the access-object heads are not the adjacent heads HGA 81B and HGA 82A (ST303: NO), the control circuit 40 carries out a normal operation without access restriction (ST305). As described above, on the basis of the determination whether or not the host command is a command requiring simultaneous access of the adjacent heads, the control circuit 40 carries out the processing of reducing the bias voltage of the assist element 10 of the HGA 82A and, upon completion of the data recording/reproducing operation (ST306), the control circuit 40 terminates this processing.

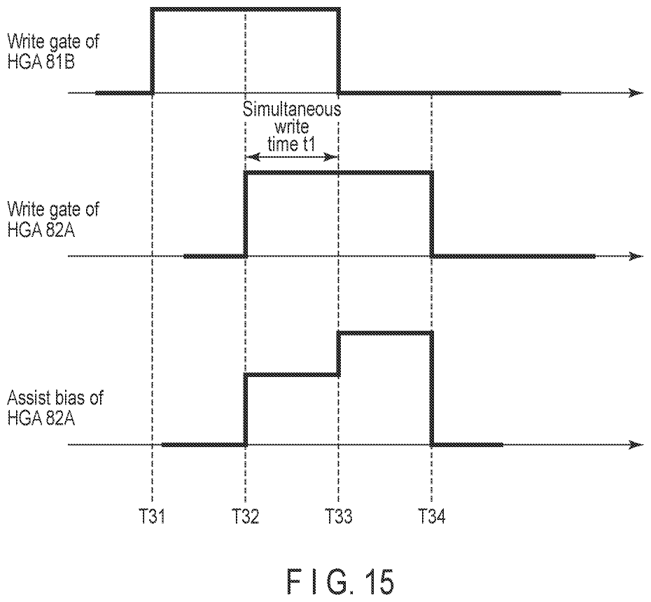

FIG. 15 is a timing chart showing an example of an operation of the processing of the step ST304 already described previously. In FIG. 15, the upper part of the drawing shows the on-state timing of the write gate of the HGA 81B, middle part thereof shows the on-state timing of the write gate of the HGA 82A, and lower part thereof shows the timing and amount of the assist bias of the assist element 10 of the HGA 82A.

As shown in FIG. 15, when the period (from time T31 to time T33) of the on-state of the write gate of the HGA 81B and period (from time T32 to time T34) of the on-state of the write gate of the HGA 82A overlap each other for a period from the time T32 to the time T33, the assist bias is reduced during the overlap period (from time T32 to time T33). Thereby, the signal to be applied to the assist element 10 of the HGA 82A becomes unsusceptible to the influence of the crosstalk noise. Accordingly, it becomes possible for the magnetic disk device 500A to avoid occurrence of a failure attributable to the crosstalk noise.

### Fifth Embodiment

In this embodiment, the arrangement of the traces is different from the second embodiment, and a case where the crosstalk noise generated from the traces of the recording head coil 11 exerts an influence on the traces of the recording head coil arranged in proximity to the above traces of the recording head coil 11 will be described below. It should be noted that configurations identical to the second embodiment described above are denoted by reference symbols identical to the second embodiment and detailed descriptions of these configurations are omitted.

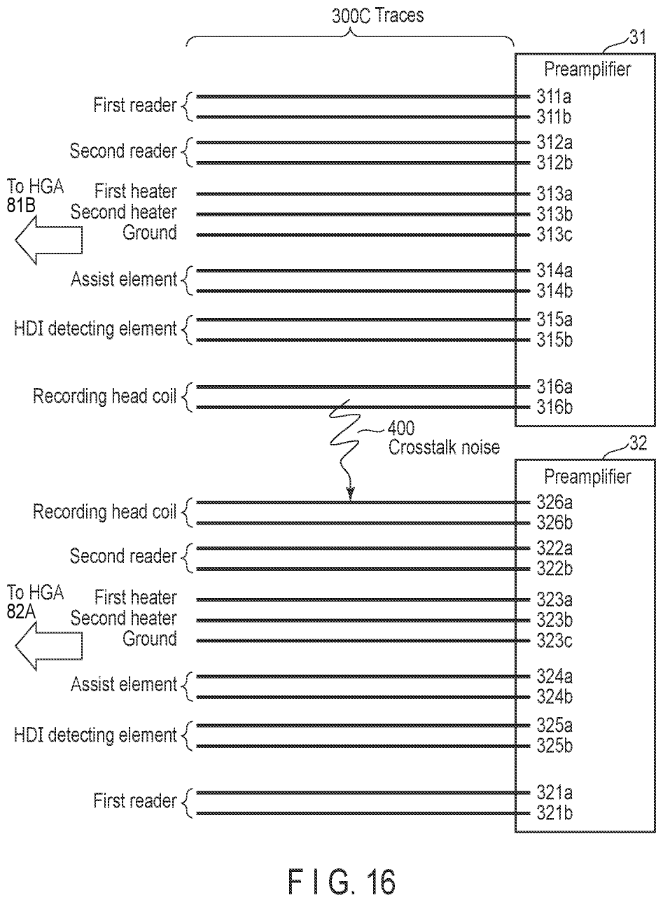

FIG. 16 is a view showing the wiring of the traces 300C of the HGA 81B and HGA 82A respectively included in the VCM 61 and VCM 62 different from each other and arranged adjacent to each other.

As shown in FIG. 16, although the arrangement of the traces from the preamplifier 31 to the HGA 81B is identical to FIG. 8 already described previously, in the arrangement of the traces from the preamplifier 32 to the HGA 82A, the traces 321a and 321b, and traces 326a and 326b switch their places with each other. That is, the traces 326a and 326b of the recording head coil 11 of the HGA 82A are arranged in proximity to the traces 316a and 316b of the recording head coil 11 of the HGA 81B. Accordingly, the signal from the first reader 75 becomes unsusceptible to the influence of the crosstalk noise, while the need for avoiding occurrence of a failure attributable to the crosstalk noise between the recording head coils 11 arranged adjacent to each other arises.

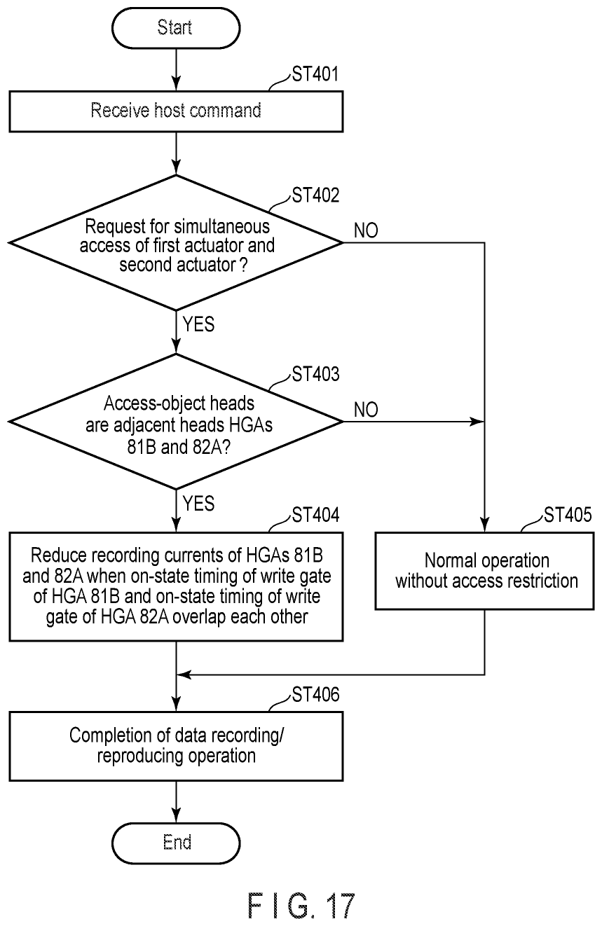

FIG. 17 is a flowchart showing an example of processing by which the control circuit 40 executes the method concerned.

As shown in FIG. 17, upon receipt of a host command (ST401), the control circuit 40 determines whether or not the command is a request for simultaneous access of the first actuator and second actuator (ST402) and, when the command is a request for simultaneous access of the actuators (ST402: YES), determines whether or not the access-object heads are the adjacent heads HGA 81B and HGA 82A (ST403). This processing identical to the steps ST101 to ST103 already described previously.

Upon determination that the access-object heads are the adjacent heads HGA 81B and HGA 82A (ST403: YES), the control circuit 40 reduces, when the on-state timing of the write gate of the HGA 81B and on-state timing of the write gate of the HGA 82A overlap each other, the recording current of each of the HGA 81B and HGA 82A (ST404).

On the other hand, upon determination that the host command is not a request for simultaneous access of the adjacent heads (ST402: NO) or upon determination that the access-object heads are not the adjacent heads HGA 81B and HGA 82A (ST403: NO), the control circuit 40 carries out a normal operation without access restriction (ST405). As described above, on the basis of the determination whether or not the on-state timing of the write gate of the recording head coil 11 and on-state timing of the write gate of the adjacent recording head coil overlap each other, the processing of reducing the recording currents is carried out and, upon completion of the data recording/reproducing operation (ST406), the control circuit 40 terminates this processing.

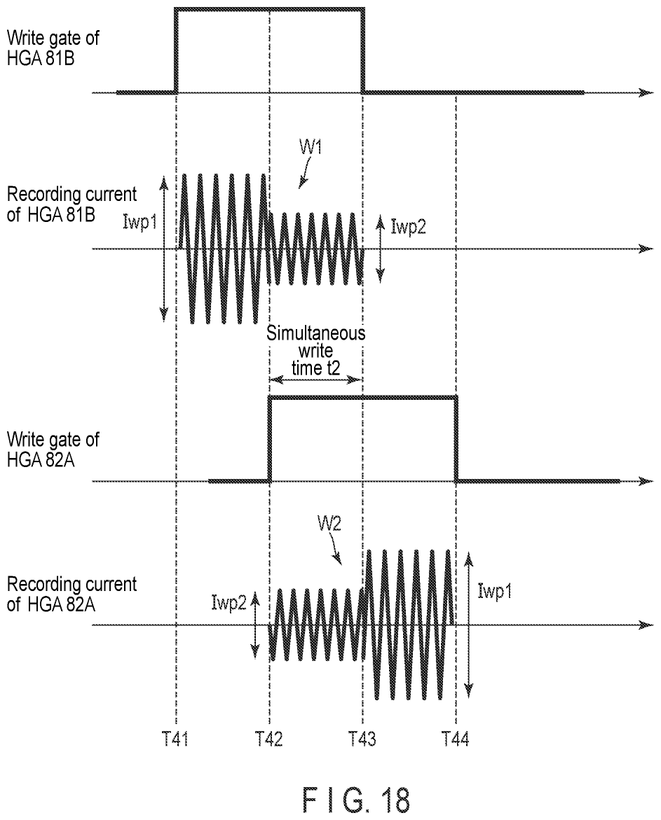

FIG. 18 is a timing chart showing an example of an operation of the processing of the step 404 already described previously. In FIG. 18, in the order from the upper side, the on-state timing of the write gate of the HGA 81B, amount of the recording current of the HGA 81B and timing for changing the amount of the recording current thereof, on-state timing of the write gate of the HGA 82A, and amount of the recording current of the HGA 82A and timing for changing the amount of the recording current thereof are respectively shown.

As shown in FIG. 18, when the on-state period (from time T41 to time T43) of the write gate of the HGA 81B and on-state period (from time T42 to time T44) of the write gate of the HGA 82A overlap each other during the period from the time T42 to the time T43, the recording current of each of the HGA 81B and HGA 82A is reduced from IwP1 to IwP2 during the overlap period (from time T42 to time T43). Thereby, the signals to be transmitted to the recording head coils 11 of the HGA 81B and HGA 82A become unsusceptible to the influence of the crosstalk noise from each other. Accordingly, it becomes possible for the magnetic disk device 500A to avoid a failure caused by the crosstalk noise.

### Sixth Embodiment

In this embodiment, the arrangement of the traces is different from the second embodiment, and a case where the influence of the crosstalk noise generated from the traces of the recording head coil 11 is exerted on the first heater 6 will be described below. It should be noted that configurations identical to the second embodiment described above are denoted by reference symbols identical to the second embodiment and detailed descriptions of these configurations are omitted.

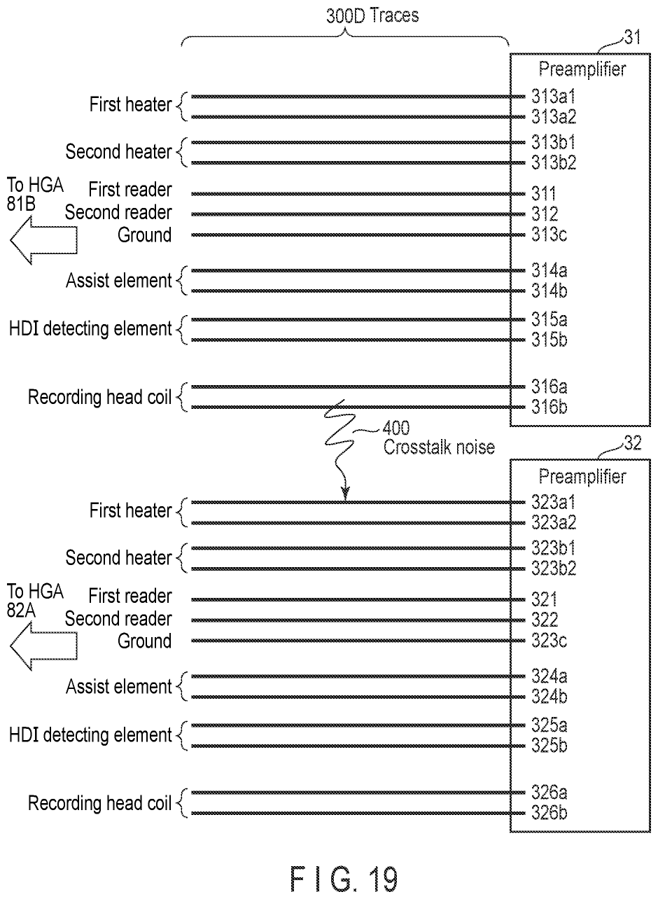

FIG. 19 is a view showing the wiring of the traces 300D of the HGA 81B and HGA 82A respectively included in the VCM 61 and VCM 62 different from each other and arranged adjacent to each other.

As shown in FIG. 19, in the traces 300D from the preamplifier 31 to the HGA 81B, the first reader 75 and second reader, and first heater 6 and second heater 7 switch their places with each other as compared with FIG. 8 and, in the traces 300D from the preamplifier 32 to the HGA 82A, the first reader 75 and second reader, and first heater 6 and second heater 7 switch their places with each other as compared with FIG. 8. That is, the traces 323a1 and 323a2 of the first heater 6 of the HGA 82A are arranged in proximity to the arrangement position of the traces 316a and 316b of the recording head coil 11 of the HGA 81B. Accordingly, the signal from the first reader 75 becomes unsusceptible to the influence of the crosstalk noise, while the need for avoiding a failure happening to the first heater 6 attributable to the crosstalk noise arises.

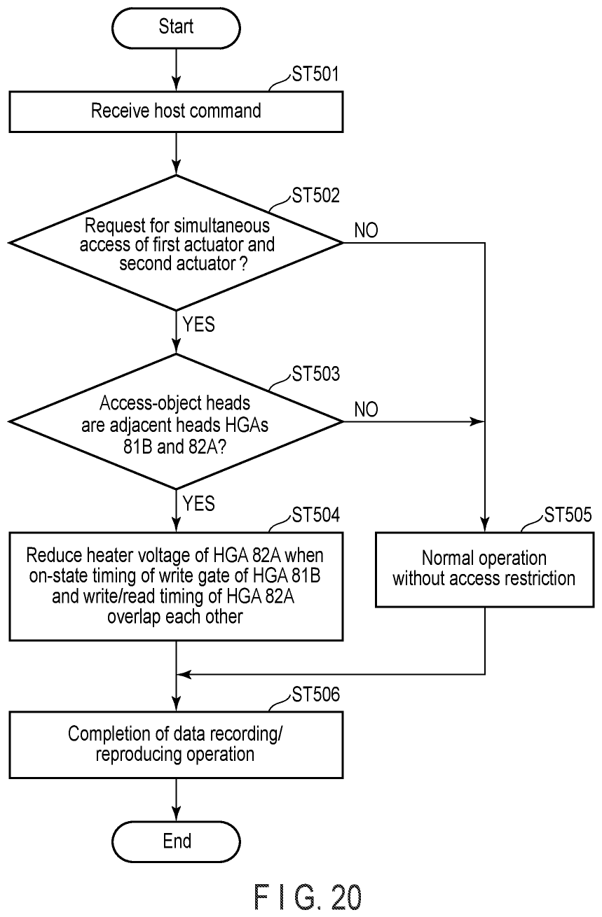

FIG. 20 is a flowchart showing an example of processing by which the control circuit 40 executes the method concerned.

As shown in FIG. 20, upon receipt of a host command (ST501), the control circuit 40 determines whether or not the command is a request for simultaneous access of the first actuator and second actuator (ST502) and, when the command is a request for simultaneous access of the actuators (ST502: YES), determines whether or not the access-object heads are the adjacent heads HGA 81B and HGA 82A (ST503). This processing is identical to the steps ST101 to ST103 already described previously.

Upon determination that the access-object heads are the adjacent heads HGA 81B and HGA 82A (ST503: YES), the control circuit 40 reduces, when the on-state timing of the write gate of the HGA 81B and on-state timing of the write gate of the HGA 82A overlap each other, the heater voltage of the HGA 82A (ST504). More specifically, the control circuit 40 reduces the voltage to be applied to the traces 323a1 and 323a2 of the first heater 6 of the HGA 82A.

On the other hand, upon determination that the host command is not a request for simultaneous access of the adjacent heads (ST502: NO) or upon determination that the access-object heads are not the adjacent heads HGA 81B and HGA 82A (ST503: NO), the control circuit 40 carries out a normal operation without access restriction (ST505). As described above, on the basis of the determination whether or not the on-state timing of the write gate of the recording head coil 11 and on-state timing of the write gate of the adjacently arranged recording head coil overlap each other, the processing of reducing the heater voltage of the HGA 82A is carried out and, upon completion of the data recording/reproducing operation (ST506), the control circuit 40 terminates this processing.

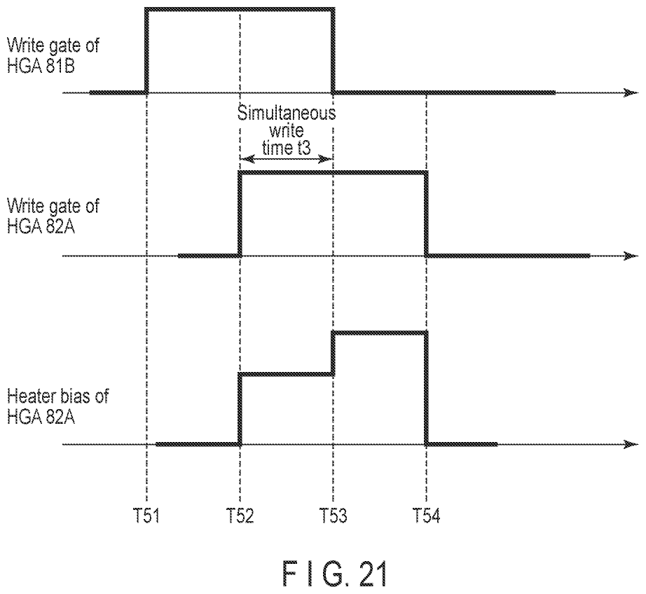

FIG. 21 is a timing chart showing an example of an operation of the processing of the step ST504 already described previously. In FIG. 21, in the order from the upper side, the on-state timing of the write gate of the HGA 81B, on-state timing of the write gate of the HGA 82A, and amount of the heater voltage of the HGA 82A and timing for changing the amount of the heater voltage thereof are respectively shown.

As shown in FIG. 21, when the on-state period (from time T51 to time T53) of the write gate of the HGA 81B and on-state period (from time T52 to time T54) of the write gate of the HGA 82A overlap each other during the period from the time T52 to the time T53, the heater bias of the HGA 82A is reduced during the overlap period (from time T52 to time T53). Thereby, the signal to be transmitted to the first heater 6 of the HGA 82A becomes unsusceptible to the influence of the crosstalk noise. Accordingly, it becomes possible for the magnetic disk device 500A to avoid occurrence of a failure attributable to the crosstalk noise.

It should be noted that although in each of the embodiments described above, the method of avoiding the influence of the crosstalk noise to be exerted on the traces adjacent to the traces 316a and 316b to be connected to the recording head coil 11 included in the HGA 80A or HGA 81B is described, the embodiments are not limited to the adjacent traces and, the techniques of the above-described embodiments can also be applied to the traces in proximity to the traces 316a and 316b to be connected to the recording head coil 11 when the influence of the crosstalk noise happens to the above traces.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
an actuator configured to drive a head stack assembly including a plurality of magnetic heads;
a preamplifier connected to each of the magnetic heads with a plurality of traces; and
a control section configured to control read/write of the plurality of magnetic heads from/to the magnetic disk through the preamplifier, wherein
while a first magnetic head among the plurality of magnetic heads executes a write operation, the control section interrupts access of a second magnetic head in proximity to the first magnetic head to the magnetic disk.

2. The magnetic disk device of claim 1, wherein
the interrupted access is a write operation of the second magnetic head, and
the control section executes the interrupted write operation of the second magnetic head after the write operation of the first magnetic head is completed.

3. A magnetic disk device comprising:
an actuator configured to drive a head stack assembly including a plurality of magnetic heads;
a preamplifier connected to each of the magnetic heads with a plurality of traces; and
a control section configured to control read/write of the plurality of magnetic heads from/to the magnetic disk through the preamplifiers, wherein
while a first magnetic head among the plurality of magnetic heads executes a write operation, the control section reduces an operating voltage of a second magnetic head positioned in proximity to the first magnetic head, the operating voltage being relative to the magnetic disk.

4. The magnetic disk device of claim 3, wherein
the plurality of traces include first traces connecting a recording head coil included in the magnetic head and the preamplifier to each other, and
the control section reduces the operating voltages with respect to the first traces connected to the recording head coil of the first magnetic head, and second traces included in the plurality of traces of the second magnetic head arranged in proximity to the first magnetic head.

5. The magnetic disk device of claim 4, wherein
the second traces are traces connecting a reader included in the second magnetic head and the preamplifier to each other.

6. The magnetic disk device of claim 4, wherein
the second traces are traces connecting a recording head coil included in the second magnetic head and the preamplifier to each other.

7. The magnetic disk device of claim 4, wherein
the second traces are traces connecting heaters included in the second magnetic head and the preamplifier to each other.

8. The magnetic disk device of claim 4, wherein
the second traces are traces connecting an assist element included in the second magnetic head and the preamplifier to each other.

9. The magnetic disk device of claim 1, wherein
the actuator includes a first actuator and a second actuator in close proximity to the first actuator in an axial direction,
the first magnetic head is included in the first actuator, and is arranged closest to the second actuator, and
the second magnetic head is included in the second actuator, and is arranged closest to the first actuator.

10. The magnetic disk device of claim 3, wherein
the actuator includes a first actuator and a second actuator in close proximity to the first actuator in an axial direction,
the first magnetic head is included in the first actuator, and is arranged closest to the second actuator, and
the second magnetic head is included in the second actuator, and is arranged closest to the first actuator.
